(19) United States
(12) Patent Application Publication
(10) Pub. No.: US 2016/0147525 A1
(43) Pub. Date: May 26, 2016

(54) SYSTEM AND METHOD FOR FIRMWARE UPDATE OF VEHICLE

(71) Applicant: HYUNDAI MOTOR COMPANY, Seoul (KR)

(72) Inventor: Hyunwoo CHOI, Gunpo-si (KR)

(21) Appl. No.: 14/838,340

(22) Filed: Aug. 27, 2015

(30) Foreign Application Priority Data
Nov. 20, 2014 (KR) 10-2014-0162957

(51) Int. Cl. G06F 9/445; H04B 7/26

(52) U.S. Cl. CPC G06F 8/65; H04B 7/26

(57) ABSTRACT

A system and a method for a firmware update of a vehicle, wherein the system includes a telematics terminal provided in a vehicle; a mobile communication server configured to provide a firmware of the telematics terminal; and a telematics server configured to manage the firmware of the telematics terminal, and provide update information of the firmware to a mobile terminal, when the update information of the firmware is received from the mobile communication server. The mobile terminal is configured to check whether download is progressed based on the update information of the firmware provided from the telematics server while the remote service is executed in a state in which ignition of the vehicle is turned off, and request update download of the firmware to the telematics server according to the check result.

### CROSS-REFERENCE TO RELATED APPLICATION

This application claims the benefit of priority to Korean Patent Application No. 10-2014-0162957, filed on Nov. 20, 2014 in the Korean Intellectual Property Office, the disclosure of which is incorporated herein in its entirety by reference.

### TECHNICAL FIELD

The present disclosure relates to a system and a method for a firmware update of a vehicle, and more particularly, to a technology of updating a firmware of a vehicle in a remote location by using a mobile terminal when the ignition of the vehicle is turned off.

### BACKGROUND

In a mobile environment such as a mobile phone, a SW (software) or FW (firmware) update has been wirelessly supported in consideration of cost and efficiency. The Firmware update technology using a wireless method is called firmware over-the-air (FOTA).

Recently, as a telematics service, such as a vehicle equipped with a communication modem, is used, a technology for wirelessly updating a SW (or FW) of a navigation device, a car audio, various controllers of vehicle, or the like including a telematics terminal of a vehicle has been developed and applied.

However, due to safety aspects in a vehicle environment dissimilar to a mobile environment, the wirelessly updating is limited during driving. Further, since vehicles cannot be always hold like a mobile phone, there may be a problem in that the wirelessly updating cannot be performed in a state of parking.

### SUMMARY

The present disclosure has been made in view of the above problems, and provides a system and a method for updating a firmware of a vehicle in a remote location by using a mobile terminal even if a driver does not ride the vehicle when the ignition of the vehicle is turned off.

The present disclosure further provides a system and a method for updating a firmware of a vehicle by utilizing the time when the vehicle does not drive so as to update the firmware of the vehicle.

In accordance with an aspect of the present disclosure, a system for firmware update of vehicle includes: a telematics terminal provided in a vehicle; a mobile communication server configured to provide a firmware of the telematics terminal; a telematics server configured to manage the firmware of the telematics terminal, and check whether the telematics terminal executes a remote service and provide update information of the firmware to a mobile terminal, when the update information of the firmware is received from the mobile communication server; and the mobile terminal configured to check whether download is progressed based on the update information of the firmware provided from the telematics server while the remote service is executed in a state in which ignition of the vehicle is turned off, and request update download of the firmware to the telematics server according to the check result. The telematics server instructs the update download of the firmware to the telematics terminal at the request of the mobile terminal. The telematics terminal releases a standby mode and connects to the mobile communication server to download update data of the firmware, when download instruction for the update data of the firmware is received from the telematics server in the standby mode. The telematics server checks whether the telematics terminal has completed the download of the update data of the firmware and guides installation of the update data of the firmware to the mobile terminal. The mobile terminal checks whether installation is progressed based on installation guide of the update data of the firmware provided by the telematics server, and requests the installation of the update data to the telematics server according to the check result. The telematics terminal installs the downloaded update data of the firmware, when installation instruction for the update data of the firmware is received from the telematics server within a predetermined time after downloading the update data. The telematics terminal reenters the standby mode, when a predetermined time is elapsed after installing the update data. The telematics terminal reenters the standby mode, when the predetermined time is elapsed after downloading the update data. The mobile terminal installs application linked to the telematics terminal and instructs installation and update of the firmware installed in the telematics terminal through the application.

In accordance with another aspect of the present invention, a method for firmware update of vehicle includes: receiving update information of a firmware from a mobile communication server by a telematics server; providing the update information of the firmware to a mobile terminal by checking whether a telematics terminal executes a remote service; receiving a request for an update download of the firmware from the mobile terminal; and instructing the update download of the firmware to the telematics terminal according to the request of the mobile terminal.

### BRIEF DESCRIPTION OF THE DRAWINGS

The objects, features and advantages of the present invention will be more apparent from the following detailed description in conjunction with the accompanying drawings, in which:

FIG. 1 is a diagram illustrating a configuration of a firmware update system of a vehicle according to an embodiment of the present invention;

FIG. 2 is a block diagram illustrating a configuration of a mobile terminal applied to a firmware update system of a vehicle according to an embodiment of the present invention; and

FIG. 3 and FIG. 4 are flowcharts illustrating a firmware update method of a vehicle according to an embodiment of the present invention.

### DETAILED DESCRIPTION

Exemplary embodiments of the present invention are described with reference to the accompanying drawings in detail. The same reference numbers are used throughout the drawings to refer to the same or like parts. Detailed descriptions of well-known functions and structures incorporated herein may be omitted to avoid obscuring the subject matter of the present invention.

Prior to a detailed description of the present invention, terms and words used in the specification and the claims shall not be interpreted as commonly-used dictionary meanings, but shall be interpreted as to be relevant to the technical scope of the invention based on the fact that the inventor may property define the concept of the terms to explain the invention in best ways. Therefore, the embodiments and the configurations depicted in the drawings are illustrative purposes only and do not represent all technical scopes of the embodiments, so it should be understood that various equivalents and modifications may exist at the time of filing this application. Some constituent elements shown in the drawings may be exaggerated, omitted or schematically drawn for the purpose of convenience or clarity.

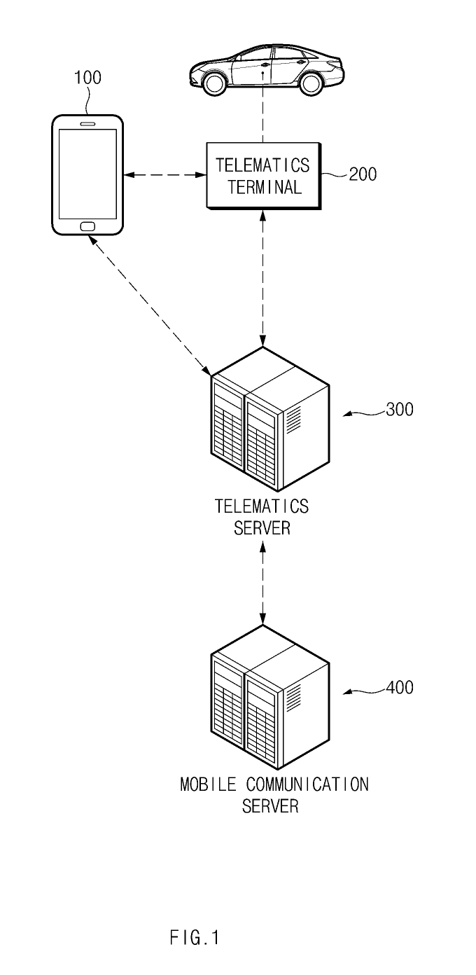

FIG. 1 is a diagram illustrating a configuration of a firmware update system of a vehicle according to an embodiment of the present invention.

Referring to FIG. 1, the firmware update system (hereinafter, referred to as “update system”) of a vehicle according to an embodiment of the present invention may update wirelessly a firmware of a telematics terminal 200 provided in a vehicle by using a firmware over-the-air (FOTA).

Here, the update system may include a mobile terminal 100, the telematics terminal 200, a telematics server 300, and a mobile communication server 400.

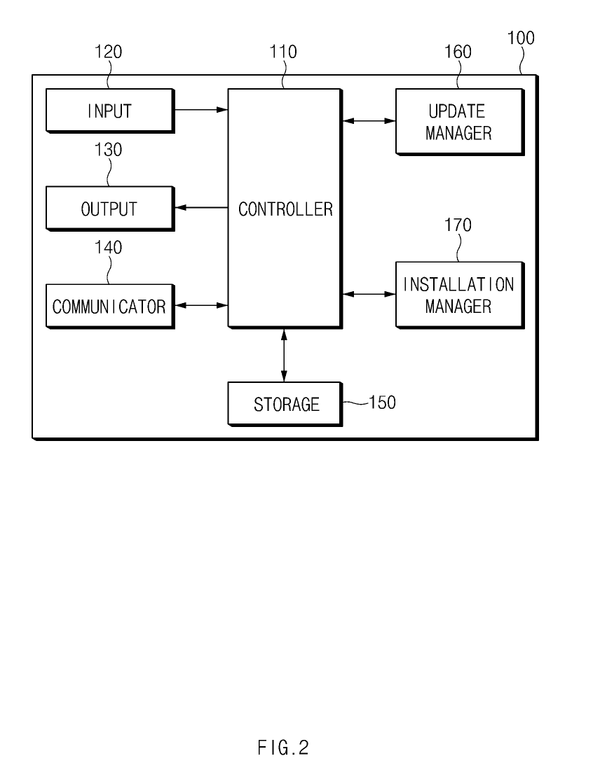

First, the mobile terminal 100 is a terminal that user holds, and any device, which can perform wireless communication and install application for vehicle control, may correspond to it. As an example, the mobile terminal 100 may include a smart phone, a laptop, a netbook, a tablet personal computer, a wearable device, and a smart watch, and the like. Obviously, the mobile terminal 100 is not limited to the above described embodiment, and various embodiments may be applicable. Thus, a detailed configuration of the mobile terminal 100 will be described with reference to an embodiment of FIG. 2.

The telematics terminal 200 is a device, which is installed in the vehicle, configured to transmit and receive e-mail or data over a wireless Internet service or retrieve information on Internet. The telematics terminal 200 may be a dedicated telematics terminal, and may be implemented by adding a telematics function to a navigation system.

The telematics terminal 200 may be provided with a firmware from the telematics server 300 through the wireless Internet service and install the firmware, and may receive guide of update information from the telematics server 300, if any update data of installed firmware exists. In this case, the telematics terminal 200 may wait until user's instruction is given while displaying the update information of the firmware through a display or the like, and may proceed the update of the firmware by connecting to the mobile communication server 400 if the instruction is given from user.

When the ignition of the vehicle is turned off, the telematics terminal 200 may terminate the operation of the vehicle as the power is turned off. Meanwhile, when executing a remote service, the telematics terminal 200 may enter in a standby mode even if the ignition of the vehicle is turned off. If the telematics terminal 200 receives guide of the update information from the telematics server 300 in the standby mode, the telematics terminal 200 may inform a remote service execution state to the telematics server 300.

In addition, if an instruction for downloading update data of a firmware is given from the telematics server 300 in the standby mode, the telematics terminal 200 may release the standby mode to switch to the power-on state and be connected to the mobile communication server 400 to download the update data.

Here, if a separate instruction is not given from the telematics server 300 until a predetermined time is elapsed after downloading the update data of the firmware, the telematics terminal 200 may be switched to the standby mode again. Meanwhile, if an installation instruction for the update data is given from the telematics server 300 within a predetermined time after downloading the update data of firmware, the telematics terminal 200 may install the update data previously downloaded.

In this case, the telematics terminal 200 may also be switched to the standby mode again, if a predetermined time is elapsed after downloading the update data of the firmware.

The mobile communication server 400 may register the firmware and/or software related with the vehicle equipped with the telematics terminal 200, and may provide the firmware at the request of the telematics server 300. In addition, when update information on the registered firmware is generated, the mobile communication server 400 may provide the update information to the telematics server 300. In this case, when the update information is generated, the mobile communication server 400 may provide relevant information automatically to the telematics server 300, and may provide relevant information only if it is requested by the telematics server 300, the telematics terminal 200, or the mobile terminal 100 depending on setting.

In addition, when the download request is given from the telematics terminal 200, the mobile communication server 400 may check information of the telematics terminal 200 and provide data related to the telematics terminal 200. The telematics server 300 may register and manage the information of the telematics terminal 200 and the information of the mobile terminal 100 that is linked to the telematics terminal 200. At this time, when receiving the update information of the firmware from the mobile communication server 400, the telematics server 300 may guide the update information of the firmware to the telematics terminal 200 requiring the update according to the update information.

At this time, when the telematics terminal 200 is executing a remote service, the telematics server 300 may guide the update information of the firmware to the mobile terminal 100 which is registered in response to corresponding telematics terminal 200. If the download of update data is requested from the mobile terminal 100, the telematics server 300 may instruct the telematics terminal 200 to download the update of firmware at the request of the mobile terminal 100, such that the telematics terminal 200 may download the update data.

If the download of update data is completed in the telematics terminal 200, the telematics server 300 may provide download completion information to the mobile communication server 400. At this time, when the telematics terminal 200 determines that the download of update data is completed, the telematics server 300 may guide the installation of the update data to the mobile terminal 100.

Further, if the installation of update data is requested from the mobile terminal 100 in the state in which the telematics terminal 200 is executing the remote service, the telematics server 300 may instruct the telematics terminal 200 to install the update data at the request of the mobile terminal 100, such that the telematics terminal 200 may install the update data. Here, the installation of update data may be performed immediately after completing the download. However, if there is no instruction in the predetermined time, it may be performed later.

FIG. 2 is a block diagram illustrating a configuration of a mobile terminal applied to a firmware update system of a vehicle according to an embodiment of the present invention.

Referring to FIG. 2, the mobile terminal 100 according to an embodiment of the present invention may include a controller 110, an input 120, an output 130, a communicator 140, a storage 150, an update manager 160, and an installation manager 170. Here, the controller 110 may process a signal transmitted between respective units of the mobile terminal 100 and control operations of the respective units in response to the processed signal.

The input 120 is a means for receiving an input of control command from user, and may correspond to a key button implemented outside of the mobile terminal 100, and may correspond to a soft key 100 implemented on the display of the mobile terminal 100. Further, the input 110 may be an input means such as a mouse, a joystick, a jog shuttle, and a stylus pen.

The output 130 may include a display which displays an operation state and results of the mobile terminal 100, and may include a speaker to guide the operation state and results in a voice.

Here, if the display is provided with a touch sensor for detecting a touch operation, it may also be used as the input device in addition to the output device. That is, if a touch sensor such as a touch film, a touch sheet, a touch pad or the like is provided to the display, the display may operate as a touch screen, and may be implemented in a form in which the input 120 and the output 130 are integrated.

At this time, the display may include at least one of a liquid crystal display (LCD), a thin film transistor liquid crystal display (TFT LCD), an organic light emitting diode (OLED), a flexible display, a field emission display (FED), and a 3D display.

The communicator 140 may include a communication module supporting a wireless communication interface with the telematics terminal, the telematics server, the mobile communication server and the like. As an example, the communication module may receive the update information of firmware from the telematics server, and may transmit a signal requesting the download of the update data of firmware. In addition, the communication module may receive the installation guide for the update data of firmware from the telematics server, and may transmit a signal requesting the installation of the update data of firmware.

Here, the communicator 140 may include a module for wireless Internet access or a module for short range communication. Here, the wireless Internet technology may include Wireless LAN (WLAN), Wireless Broadband (Wibro), Wi-Fi, World Interoperability for Microwave Access (Wimax), High Speed Downlink Packet Access (HSDPA) and the like. In addition, the short range communication technology may include Bluetooth, ZigBee, Ultra Wideband (UWB), Radio Frequency Identification (RFID), Infrared Data Association (IrDA) and the like.

The storage 150 may store a setting for the operation of mobile terminal 100. As an example, the storage 150 may store information for communicating with the telematics terminal provided in the vehicle. Further, the storage 150 may store an application which instructs the installation and/or update of the firmware installed in the telematics terminal.

Here, the storage 150 may include at least one of a storage media among Flash Memory Type, Hard Disk Type, Multimedia Card Micro Type, a card type memory (e.g., SD or XD memory and the like), magnetic memory, magnetic disk, optical disk, Random Access Memory (RAM), Static Random Access Memory (SRAM), Read-Only Memory (ROM), Programmable Read-Only Memory (PROM), and Electrically Erasable Programmable Read-Only Memory (EEPROM).

The update manager 160 and the installation manager 170 may operate when application installed in the mobile terminal 100 is executed, and may operate separately from application depending on the environment of the mobile terminal 100.

When the update information of the firmware is received from the telematics server, the update manager 160 may enable to display the update information through the display of the output 130. In this case, the update manager 160 may enable to simultaneously display a message that checks the progress of the update.

If the progress of the update is requested from user, the update manager 160 may request the download of firmware update to the telematics server. Then, when the download for the update data of the firmware is completed, the update manager 160 may guide user by displaying the download completion information of update data through the display of the output 130.

The installation manager 170 may instruct the installation of the firmware and/or the update data of firmware. At this time, when installation guide for the update data of firmware is received from the telematics server, the installation manager 170 may enable to display installation guide information of the update data through the display of the output 130. In this case, the installation manager 170 may simultaneously display a message that checks the installation progress of the update data.

If the installation progress is requested from user, the installation manager 170 may request the installation of the update data of firmware to the telematics server. When the installation of the update data of firmware is completed, the installation manager 170 may guide user by displaying the installation completion information of the update data through the display of the output 130.

The operation flow of an apparatus according to an embodiment of the present invention configured as described above is described in more detail.

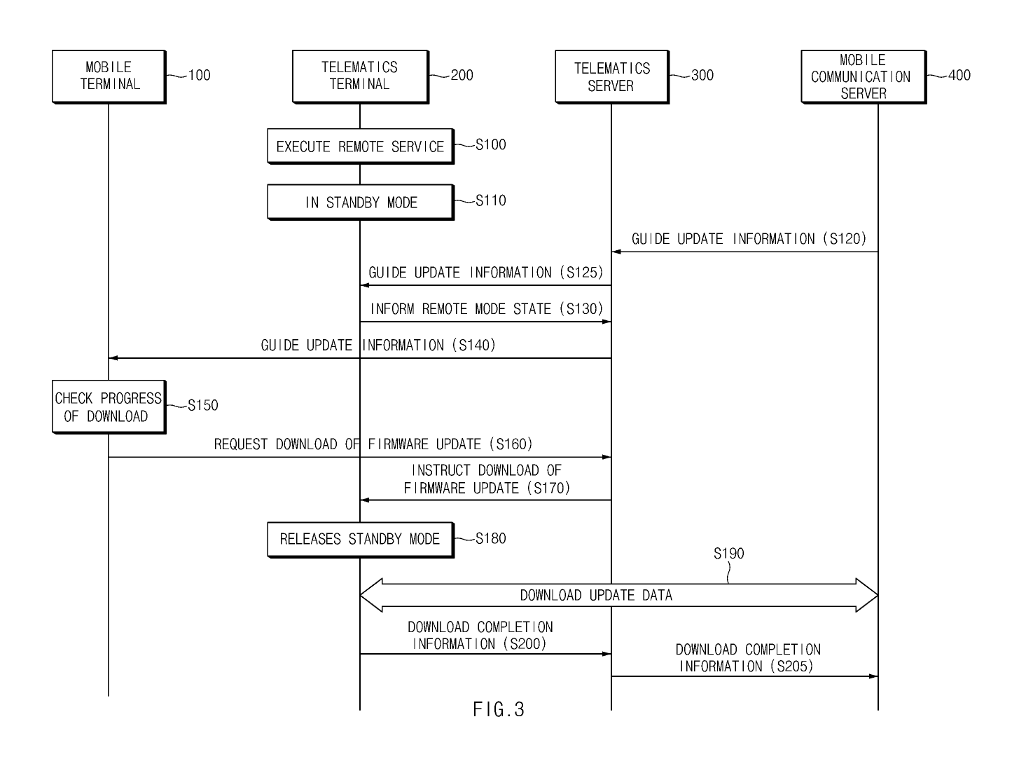

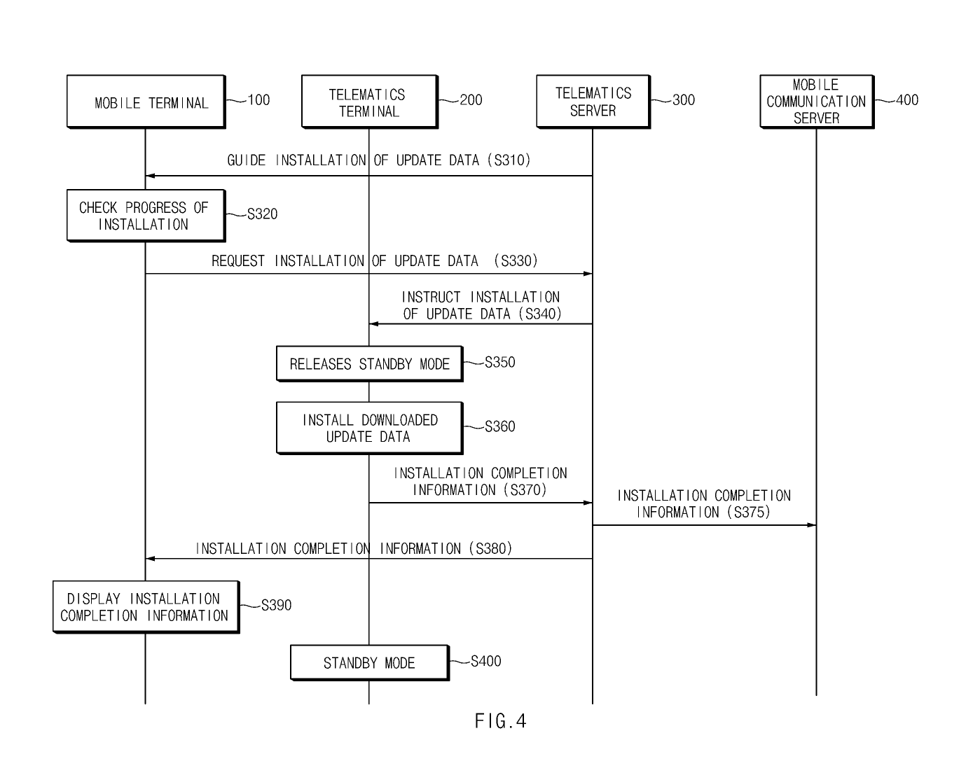

FIG. 3 and FIG. 4 are flowcharts illustrating a firmware update method of a vehicle according to an embodiment of the present invention.

First, referring to FIG. 3, when the remote service is executed in the telematics terminal 200 (S100) during in the standby mode (S110), if update information for the firmware registered in the communication server 400 is generated, the mobile communication server 400 guides the update information to the telematics server 300 (S120).

At this time, the telematics server 300 guides the update information of the firmware to the telematics terminal 200 which requires update according to the update information of the firmware received from the communication server 400 (S125). Here, when receiving guide of update information from the telematics server 300 in the standby mode, the telematics terminal 200 may inform the remote service execution state to the telematics server 300 (S130).

The telematics server 300 checks that the telematics terminal 200 is executing the remote service, and then guides the update information of the firmware to the mobile terminal 100 registered in response to corresponding telematics terminal 200 (S140). When receiving the update information of the firmware from the telematics server 300, the mobile terminal 100 displays the update information through the display and checks the progress of the download of update data depending on input from user (S150), and requests the download of firmware update to the telematics server 300 when the download is progressed (S160). At this time, the telematics server 300 instructs the download of firmware update to the telematics terminal 200 at the request of the mobile terminal 100 (S170).

The telematics terminal 200 releases the standby mode when an instruction is given from the telematics server 300 (S180), and downloads the update data by connecting to the mobile communication server 400 (S190). In this process, the mobile communication server 400 may check the information of the telematics terminal 200.

When the download of the update data is completed, the telematics terminal 200 provides download completion information to the telematics server 300 (S200). The telematics server 300 provides the download completion information of the telematics terminal 200 to the mobile communication server 400 (S205). Although not shown in FIG. 3, the telematics server 300 may provide the download completion information of the telematics terminal 200 to the mobile terminal 100.

Meanwhile, when it is checked that the telematics terminal 200 has completed the download, as shown in FIG. 4, the telematics server 300 may guide the installation of the update data to the mobile terminal 100 (S310). At this time, the mobile terminal 100 displays installation guide information of the update data received from the telematics server 300 to check the progress of installation from user (S320).

If the progress of installation is requested from the user, the mobile terminal 100 requests the installation of the update data of firmware to the telematics server 300 (S330). At this time, the telematics server 300 instructs the installation of the update data to the telematics terminal 200 at the request of the mobile terminal 100 (S340).

When the installation instruction for the update data is given from the telematics server 300 after downloading the update data of firmware, the telematics terminal 200 releases the standby mode (S350), and installs the previously downloaded update data (S360). Obviously, if the standby mode has been already released in the telematics terminal, the step of ‘S350’ may be omitted.

When the telematics terminal 200 completes the installation of the update data, the telematics terminal 200 provides the installation completion information to the telematics server 300 (S370). At this time, the telematics server 300 provides the installation completion information of the telematics terminal 200 to the mobile communication server 400 and the mobile terminal 100 (S375, S380).

Thus, the mobile terminal 100 displays the installation completion information of the telematics terminal 200 received from the telematics server 300 through the display so as to guide the user (S390). In this case, the telematics terminal 200 may be switched to the standby mode again after completing the installation of the update data (S400).

The above mentioned process may be directly implemented by a hardware, a software module, or a combination of the two executed by a processor. The software module may reside in a storage medium, that is, in a memory and/or a storage such as a RAM memory, a flash memory, a ROM memory, an EPROM memory, an EEPROM memory, a register, a hard disk, a removable disk, and CD-ROM. The exemplary storage medium may be coupled to a processor, and the processor may read information from the storage medium and write information to the storage medium. Alternatively, the storage medium may be integrated in the processor. The processor and the storage medium may reside in an application specific integrated circuit (ASIC). The ASIC may reside in a user terminal. Alternatively, the processor and the storage medium may reside in the user terminal as an individual component.

According to an embodiment of the present invention, the firmware of vehicle may be updated in a remote location by using a mobile terminal even if a driver does not ride in the vehicle when the ignition of the vehicle is turned off, and the firmware of vehicle may be updated by utilizing the time when the vehicle does not drive.

Although exemplary embodiments of the present invention have been described in detail hereinabove, it should be clearly understood that many variations and modifications of the basic inventive concepts herein taught which may appear to those skilled in the present art will still fall within the spirit and scope of the present invention, as defined in the appended claims.

What is claimed is:

1. A system for firmware update of vehicle, the system comprising:
a telematics terminal provided in a vehicle;
a mobile communication server configured to provide a firmware of the telematics terminal;
a telematics server configured to manage the firmware of the telematics terminal, and check whether the telematics terminal executes a remote service and provide update information of the firmware to a mobile terminal, when the update information of the firmware is received from the mobile communication server; and
the mobile terminal configured to check whether download of the firmware is progressed based on the update information of the firmware provided from the telematics server while the remote service is executed in a state in which ignition of the vehicle is turned off, and request update download of the firmware to the telematics server according to the check result,
wherein the telematics server instructs the update download of the firmware to the telematics terminal at the request of the mobile terminal.

2. The system of claim 1, wherein the telematics server checks whether the telematics terminal has completed the download of the update data of the firmware and guides installation of the update data of the firmware to the mobile terminal.

3. The system of claim 2, wherein the mobile terminal checks whether installation is progressed based on installation guide of the update data of the firmware provided by the telematics server, and requests the installation of the update data of the firmware to the telematics server according to the check result.

4. The system of claim 1, wherein the telematics terminal releases a standby mode and connects to the mobile communication server to download update data of the firmware, when download instruction for the update data of the firmware is received from the telematics server in the standby mode.

5. The system of claim 4, wherein the telematics terminal installs the downloaded update data, when installation instruction for the update data of the firmware is received from the telematics server within a predetermined time after downloading the update data.

6. The system of claim 5, wherein the telematics terminal reenters the standby mode, when a predetermined time is elapsed after installing the update data.

7. The system of claim 4, wherein the telematics terminal reenters the standby mode, when a predetermined time is elapsed after downloading the update data.

8. The system of claim 1, wherein the mobile terminal installs application linked to the telematics terminal and instructs installation and update of the firmware installed in the telematics terminal through the application.

9. A method for firmware update of vehicle, the method comprising:
receiving update information of a firmware from a mobile communication server by a telematics server;
providing the update information of the firmware to a mobile terminal by checking whether a telematics terminal executes a remote service;
receiving a request for an update download of the firmware from the mobile terminal; and
instructing the update download of the firmware to the telematics terminal according to the request of the mobile terminal.

10. The method of claim 9, further comprising:
releasing, by the telematics terminal, a standby mode when the download instruction for update data of the firmware is received from the telematics server in the standby mode; and
downloading, by the telematics terminal, the update data of the firmware by connecting to the mobile communication server.

11. The method of claim 9, by the telematics server, further comprising:
guiding installation of update data of the firmware to the mobile terminal by checking whether the telematics terminal has completed download of the update data of the firmware; and
instructing installation of the update data of the firmware to the telematics terminal according to the request of the mobile terminal when receiving the request of installation of the update data of the firmware from the mobile phone.

12. The method of claim 11, by the telematics terminal, further comprising:
installing the downloaded update data of the firmware, when installation instruction for update data of the firmware is received from the telematics server within a predetermined time after downloading the update data of the firmware.
